(19) United States
(12) Patent Application Publication
(10) Pub. No.: US 2011/0252941 A1
(43) Pub. Date: Oct. 20, 2011

(54) Fix-mounted Guitar Bridge

(76) Inventor: Lloyd Alfred Prins, Tulsa, OK (US)

(21) Appl. No.: 13/088,325

(22) Filed: Apr. 15, 2011

Related U.S. Application Data
(60) Provisional application No. 61/324,725, filed on Apr. 15, 2010.

(51) Int. Cl. G10D 3/04

(52) U.S. Cl. 84/298

(57) ABSTRACT

Disclosed is a guitar bridge having a body comprised of a main base plate and a tone device. The bridge main base plate mounts flush to the guitar main body upper surface by a plurality of coupling screws. The bridge tone device extends perpendicular to the underside surface of main base plate into and out of contact from a tone chamber formed into the top surface of the guitar main body. Strings are threaded over a plurality of saddles then through a plurality of holes formed in the bridge main base plate. Strings continue through a plurality of holes formed through the guitar main body where the strings terminating ball ends are anchored against the underside surface of guitar main body.

### CROSS REFERENCE TO RELATED APPLICATION

This application claims the benefits of Provisional Patent Application number 61/324,725 filed Apr. 15, 2010.

### BACKGROUND OF THE INVENTION

U.S. Pat. No. 4,361,068 issued to Helmut F. K. Schaller Nov. 30, 1982

U.S. Pat. No. 2,741,146 issued to C. Leo Fender Apr. 10, 1956

U.S. Pat. No. 4,497,236 issued to Floyd D. Rose Feb. 5, 1985

U.S. Pat. No. 7,838,752 Frank LaMarra Nov. 23, 2010

This invention relates to a device for attaching strings to the main body of a stringed musical instrument such as a guitar. Typically referred to as a bridge, this device serves as a termination point for one end of the string. Bridge configurations are generally “fixed” as with a tail piece style bridge, “floating” as with a tremolo style bridge, or a configuration of both.

A guitar bridge of U.S. Pat. No. 4,361,068 issued to Helmut F. K. Schaller embodies the typical fixed style guitar bridge. Among the benefit of Schaller's design is that it provides a secure method of anchoring the guitar strings and provides a good transfer of sound energy from the strings to the instrument's main body.

The tremolo style bridge similar to U.S. Pat. No. 2,741,146 issued to C. Leo Fender provides guitar players a method of creating a vibrato affect. This design incorporates a pivoting main base plate, a number of springs to apply balancing tension to the strings, and an apparatus Fender described as the “Bar” to join the bridge base plate to the springs.

Another design of the tremolo bridge is U.S. Pat. No. 4,497,236 issued to Floyd D. Rose. Rose improved upon the stability of Fender's design but at the heart of Rose's invention were the bridge main base plate, balancing springs and the device that coupled the two together which Rose described as a “Flange”.

The “Bar” as Fender described and the “Flange” as Rose described is describe by David G. Lee in U.S. Pat. No. 4,497,236 as the “Foot”. In U.S. Pat. No. 6,084,166 issued to I-Ping Chang, this same component is described as the “Bottom block to support the bridge body”.

In a design to merge the tremolo style bridge with the fixed style bridge, Frank LaMarra in U.S. Pat. No. 7,838,752 described a modification to the Fender tremolo style bridge whereby Fender's “Bar” is held firm against the guitar main body with stop screws. LaMarra in his design describes Fender's “Bar” as a “Sustain Block”. By eliminating the movement of the sustain block, LaMarra converted a tremolo style bridge to a fixed style bridge with sustain block. LaMarra makes no claim to a sustain block used to shape tone.

Each component of the stringed instrument contributes to its tone. For this reason, a guitar player will select one style of bridge over another. The apparatus described as the “Bar” by Fender, the “Foot” by Rose, and the “sustain block” by LaMarra is believed by many to contribute to tone. Many today simply refer to this apparatus as “the block”.

Whereas the block has a primary purpose to join the bridge main base plate to the balancing springs, the size, shape and configuration of the block is dictated by its main purpose. That purpose being to anchor tremolo springs and join the bridge main base plate. Further, LaMarra's design relies on the block to serve as the anchoring point for the guitar strings. This further limits the configuration of the block.

While the devices described above may be suitable for the particular purpose employed, or for general use, they would not be as suitable for the purposes of the present invention as disclosed hereafter. What is lacking is a bridge design that has to benefits of the fixed style bridge and the tone enhancing potential, yet not achieved by the block common in the tremolo bridge design.

### SUMMARY OF INVENTION

The objective of this guitar bridge invention is to provide an improved transfer medium for coupling sonic energy from the strings to the guitar main body. This is accomplished through a bridge main base plate that is fix-mounted to the surface of the guitar. An appendage, herein after referred to as tone device, contiguous to the bridge main base plate, extends from the lower surface of the bridge main base plate into a tone cavity formed into the surface of the guitar. The tone device is configured such that string vibration sustains longer, acoustic amplitude is increased, and frequencies are increased or attenuated, thereby giving the guitar player another means of personalizing his/her tone.

Differentials in such things as metal density and the shape and/or configuration of the tone device impact vibrational efficacy and thereby the production of sound. By modifying these components, this invention can be configured to meet the personalized tone of the musician.

### BRIEF DESCRIPTION OF THE DRAWINGS

FIG. 1 is a perspective view of a guitar body, headstock, and orientation of present invention;

FIG. 2 is a top elevation view of present invention;

FIG. 3 is a bottom elevation view thereof;

FIG. 4 is an isometric view thereof;

FIG. 5 is a cross-sectional view taken along line 5-5 in FIG. 2;

FIG. 6 is rear plan view of present invention;

FIG. 7 is a bottom plan view thereof;

FIG. 8 is a rear plan view of alternate configuration of present invention;

FIG. 9 is a bottom plan view thereof;

FIG. 10 is a rear plan view of alternate configuration of present invention;

FIG. 11 is a bottom plan view thereof.

### DETAILED DESCRIPTION OF THE INVENTION

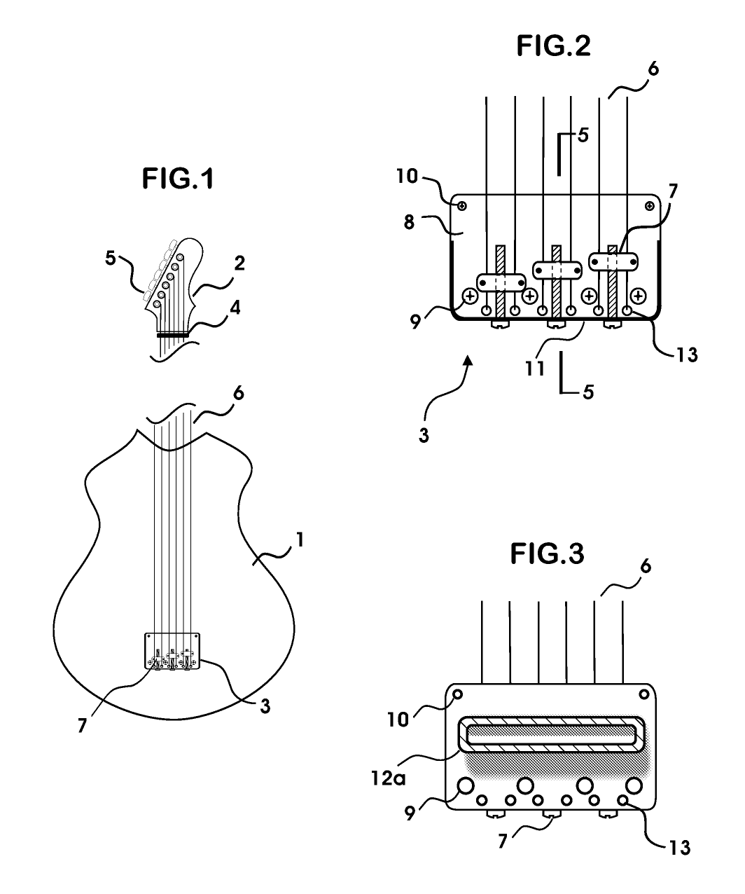

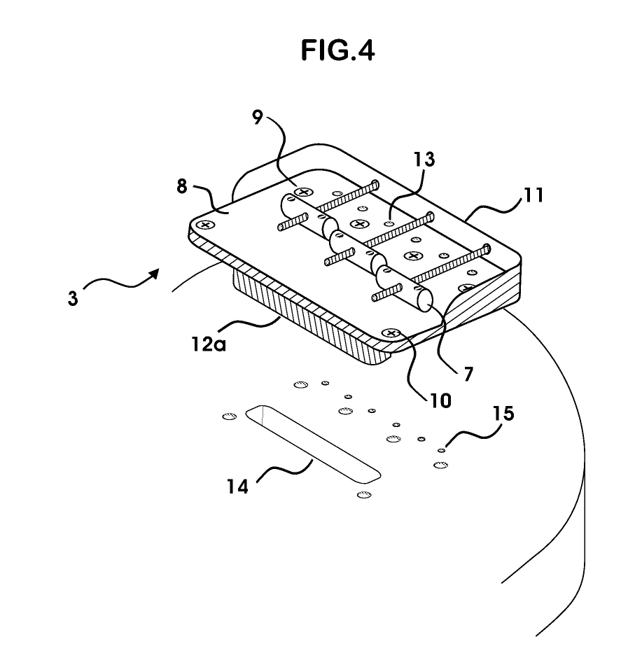

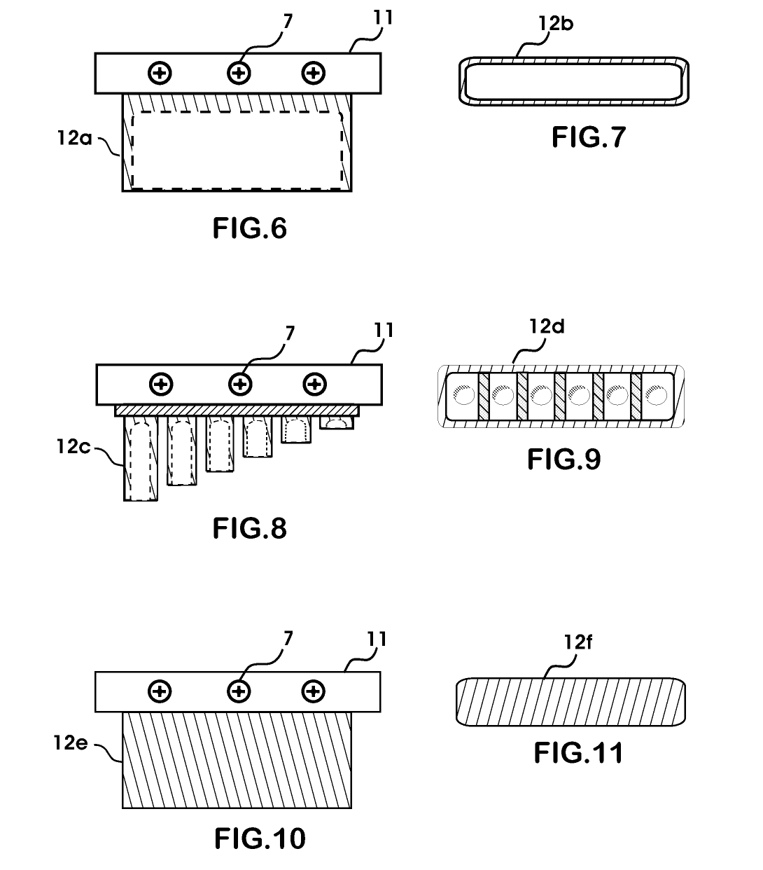

The bridge 3 of present invention is illustrated in FIG. 1, FIG. 2 and FIG. 4 disclose the bridge 3 which has a body that comprises a main base plate 8, back and side walls 11, a plurality of adjustable saddles 7, and appendage hereinafter referred to as tone device, 12a. Bridge 3 is primarily rectangular with its width dictated by the number of strings 6 and its length determined by number and style of saddles 7. The tone device 12a is formed from the lower surface of base plate 8 and is machined from a contiguous part of the material used in the fabrication of base plate 8 and walls 11. The size and shape of tone device 12a shown here is primarily rectangular but can be configured in a variety of profiles as shown in FIG. 6-11 12a-f. Tone device 12a-f extends perpendicular from base plate 8 into tone chamber 14 where it suspends out of contact with guitar main body 1. The size and shape of the tone chamber is determined by the size and shape of tone device 12a-f.

In the preferred embodiment, limitations to the size, shape and configuration of tone device 12a-f is limited such that its outside dimension stay within the boundaries of the bridge main base plate 8 and out of contact with mounting screw 9-10 and string holes 13.

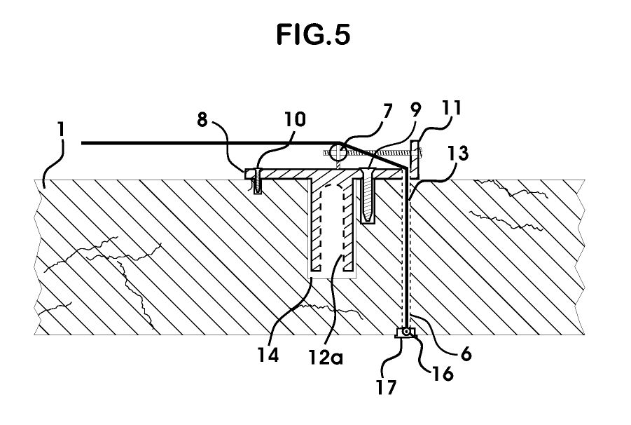

Referring to FIG. 1, a guitar's sound is achieved by the vibration of a guitar string or strings 6. The string runs longitudinally from a tuning mechanism 5 located on the guitar headstock 2, to its opposite end at the bridge assembly 3 where it terminates through the guitar main body FIG. 5 15 in an anchored mounting on the lower surface of the main guitar body. This mounting is achieved with an over-sized ball-end FIG. 5 16 that is held firmly against a metal ferrule 17 which inserted into the lower surface of the guitar main body. As the tension of the guitar string increases with tuning, the string ball-end is held in place against the ferrule. To achieve optimum pitch, the must guitar string must be precise in it length. This is achieved with string break-over points at the nut 4 and at the bridge saddle 7. For precise calibration, saddle 7 is typically adjustable along the string's longitudinal axis.

The ability of the guitar string to vibrate in a favorable, sustained and audible fashion is determined by among other things, the selection of wood used in the main body 1 construction, and the precision with which component parts mate to and couple with the guitar main body 1. The present bridge invention 3 provides such precision. Where traditional bridges are stamped from cold role carbon steal, the present invention is machine milled from a common billet of material. The bridge base plate 8, back and side walls 11, and tone device 12a-f are fabricated from a contiguous billet of material, thereby enhancing the transfer of sound energy throughout the bridge. In this bridge invention the tone device 12a-f does not rely on coupling screws to join it to the bridge base plate 8.

As a guitar string is plucked, the string begins to vibrate which in turn causes the bridge to vibrate. The precision milled surface of the underside of the bridge main base plate 8 provides the optimum transfer of the bridge vibration to the wood of the main guitar body 1. Additionally, the added mass of the bridge 3 caused by the addition of the tone device 12a-f provides extended sustain of the vibration within the bridge 3. Further, a modification to the shape, size, configuration, and material of the tone device 12a-f establishes variations in tonal frequencies and the amplitude of the vibration of the bridge 3. Further, the tone device suspends into a tone chamber 14 in the guitar main body and out of contact with the side wall of the chamber 14, thereby allowing the tone device 12a-f to vibrate longer and with greater amplitude.

Although the particular embodiments of the disclosed bridge invention have been describe in detail herein with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed:

1. A bridge for securing strings to a stringed musical instrument comprising:
a) a main base plate;
b) at least one formed hole in said base plate for fix-mounting bridge to instrument;
c) at least one coupling device used to mount bridge to instrument;
d) at least one adjustable string saddle; and
e) at least one hole for receiving an instrument string.

2. The bridge according to claim 1, further comprising an appendage, hereinafter referred to as tone device, extending perpendicular from the lower surface of said bridge main base plate.

3. A method of claim 2, of increasing, decreasing, attenuating sonic frequencies, or otherwise modifying the sonic characteristics of the bridge of claim 1, consisting of different embodiments of the size, shape, configuration and orientation of said tone device.

4. A method of claim 1, wherein said bridge is constructed from metal, ceramic, plastic, petroleum-based composite materials, man-made composite materials, carbon fiber, carbon composite materials, bone, synthetic bone materials, wood or wood composite materials.

5. A method of claim 1, of increasing, decreasing, attenuating sonic frequencies, or otherwise modifying the sonic characteristics of said bridge consisting of alternative materials from which said bridge is constructed.

6. A tone chamber cut into the musical instrument's main body to receive the tone device of claim 2.

7. A method of claim 6, of increasing, decreasing, attenuating sonic frequencies, or otherwise modifying the sonic characteristics of the bridge of claim 1, consisting of varying embodiments of the size, shape, depth and orientation of said tone chamber.
